(19) United States
(12) Patent Application Publication
(10) Pub. No.: US 2026/0099802 A1
(43) Pub. Date: Apr. 9, 2026

(54) A METHOD FOR HANDLING SHIPMENT OF A CONTAINER AND RELATED ELECTRONIC DEVICE

(71) Applicant: MAERSK A/S, Copenhagen K (DK)

(72) Inventors: Sachin Dadasaheb CHAUDHARI, Bangalore (IN); Sunil Kumar CHINNAMGARI, Bangalore (IN); Rakesh Nagaraj AMMAN, Bangalore (IN); Prasad SETTYPALLE, Bangalore (IN); Uday Kumar PAPICHETTY, Bangalore (IN)

(21) Appl. No.: 19/112,892

(22) PCT Filed: Sep. 7, 2023
(86) PCT No.: PCT/EP2023/074657

§ 371 Date: Mar. 18, 2025

(30) Foreign Application Priority Data
Sep. 21, 2022 (DK) PA202270460

(51) Int. Cl. G06Q 10/0835; G06Q 10/083

(52) U.S. Cl. CPC G06Q 10/0835; G06Q 10/0838

(57) ABSTRACT

Disclosed is a method, performed by an electronic device, for handling shipment of a container. The method includes obtaining historical data associated with container shipment. The method includes determining, based on the historical data, a container usage pattern associated with the container. The method includes generating, based on the container usage pattern, a time extension package associated with the container shipment characterized by package data. The package data comprises a time extension parameter indicative of a time period for extending a return time of the container and a cost parameter associated with the time extension parameter. The method includes predicting, for one or more time extension packages of a plurality of time extension packages, a selection parameter by applying a machine-learning model to the historical data and previous package data. The selection parameter is indicative of a likelihood of selection of the respective time extension package.

The present disclosure pertains to the field of transport and freight. The present disclosure relates to a method for handling shipment of a container and related electronic device.

### BACKGROUND

When shipping a container, many factors can affect the shipping, including when the container is returned to the shipping company, e.g. after delivering its content. The booking of the container can include a time extension package that allows a user to extend the time to return the container. The user selects the time extension package at the booking time. It is difficult to foresee at that time how long of a time extension is likely to be required. This can impact the availability of containers for the shipping company.

### SUMMARY

Accordingly, there is a need for an electronic device and a method for handling shipment of a container, which mitigate, alleviate, or address the shortcomings existing and provide adaptive time extension packages, which can lead to improve container resource management.

Disclosed is a method, performed by an electronic device, for handling shipment of a container. The method comprises obtaining historical data associated with container shipment. The method comprises determining, based on the historical data, a container usage pattern associated with the container. The method comprises generating, based on the container usage pattern, a time extension package associated with the container shipment characterized by package data. The package data comprises a time extension parameter indicative of a time period for extending a return time of the container and a cost parameter associated with the time extension parameter. The method comprises predicting, for one or more time extension packages of a plurality of time extension packages, a selection parameter by applying a machine-learning model to the historical data and previous package data. The selection parameter is indicative of a likelihood of selection of the respective time extension package. Optionally, the method comprises determining, based on the selection parameter for the one or more time extension packages, extension cost data associated with time extension of the container shipment.

The method comprises optionally providing, based on the extension cost data, updated package data associated with the time extension package.

Further, an electronic device is disclosed. The electronic device comprises a memory, an interface, and a processor. The electronic device is configured to perform any of the methods disclosed herein.

Disclosed is a computer readable storage medium storing one or more programs, the one or more programs comprising instructions, which when executed by an electronic device cause the electronic device to perform any of the methods disclosed herein.

It is an advantage of the present disclosure that the disclosed electronic device and method provide an improved provisioning of time extension packages, which allow more optimal time extension periods and associated costs. The disclosed technique improves transparency of the provisioning of the time extension packages, for the shipping company and the user. Further, the disclosed technique allows providing adaptive time extension packages. The disclosed technique improves inventory management by taking into account the container availability.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a flow-chart illustrating an exemplary method, performed by an electronic device, for handling shipment of a container according to this disclosure, and

FIG. 2 is a block diagram illustrating an exemplary electronic device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

A container disclosed herein refers to a housing where items to be shipped are enclosed for transport. For example, a container may be seen as a bin. The term container may be used interchangeable with bin in the present disclosure. For example, the container may be an intermodal container, which is thus standardised and built for intermodal freight transport. For example, the container can be carried by ship, rail and road vehicle.

An item disclosed herein refers to an object that is to be placed in a container for transport. For example, an item may be seen as an item of cargo, e.g., an item of freight, e.g., an object to be shipped. Note that the terms item may be used interchangeable with cargo. For example, an item may comprise commodities that can be placed into containers, such as goods, such as consumer goods of large manufacturing corporations, generic consumer goods as shoes, clothing, toys and fast-moving-consumer-goods as packaged foods, beverages, toiletries, and medicines.

For example, the items disclosed herein may be seen as commodities that can be packed into e.g., rectangular stackable cartons with variable weights and volumes that are transported in one or more containers (e.g., in one or more dry containers).

For mitigating the risk of penalty inviting delays, a time extension package can be provided to a user when booking a shipment of a container. The time extension package can be seen as an option and/or a product for extending the return time of the container to the shipping company. For example, the time extension package can be seen as a time extension offer and/or a time extension proposal. For example, the time extension can be selected by a user for 14 days maximum at a flat rate/day. Determining the associated cost for such a time extension package is very critical in logistic and shipping industry.

It is to be noted that the delayed return of a container is detrimental in that other users may want to reserve the same container and possibly at a higher shipping rate.

Due to trade-offs between revenue generated by various products, prevailing market conditions and various other factors, it is very challenging to provide a time extension package including a time extension parameter and associated cost which is optimal and/or advantageous for the shipping company and other users. There are no readily available solutions which can be quickly customized to solve this challenge. If the time extension packages are not optimal then there could be heavy cannibalization effect between revenue streams which negatively impact the revenue. Thus, providing an optimal time extension package may lead to mitigating any negative impact.

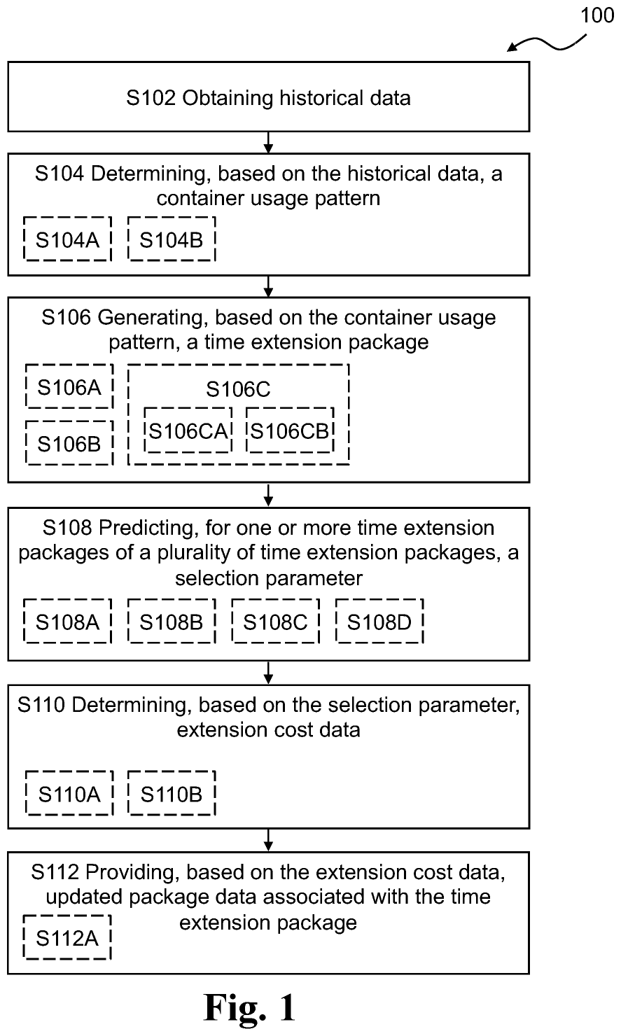

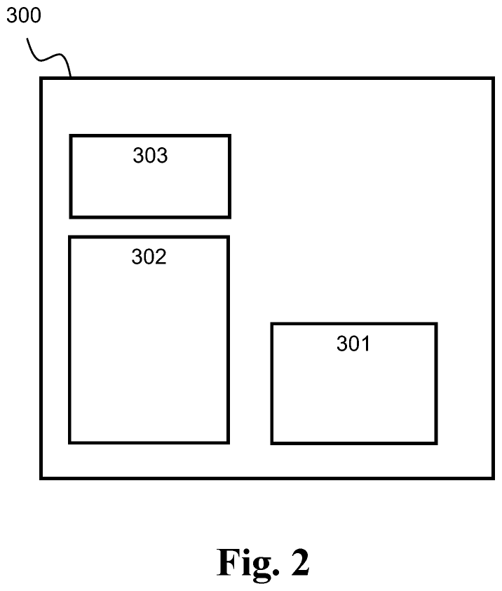

FIG. 1 shows a flow-chart of an exemplary method 100, performed by an electronic device, for handling shipment of a container according to the disclosure. The electronic device is the electronic device disclosed herein, such as the electronic device 300 of FIG. 2.

The method 100 comprises obtaining S102 historical data associated with container shipment. In one or more examples, container shipment can be seen as shipping (e.g., transporting) one or more containers including one or more items. For example, the historical data is associated with one or more containers. For example, obtaining the historical data comprises obtaining the historical data by querying one or more repositories (e.g., one or more databases and/or one or more data warehouses). For example, the historical data comprise one or more of: booking data, shipment data and equipment data associated with previous container shipments, such as previous activity of a container (e.g., previous shipping of one or more items enclosed in a container). The booking data comprises information associated with a booking of one or more containers. The shipment data comprises information associated with a shipping of one or more items enclosed in one or more containers. The equipment data comprise information associated with a number of equipment used during shipping and/or information associated with a type of equipment used during shipping. In some examples, the historical data comprises information indicative of a data indicative of a request a container and/or a date for returning a container (e.g., an expected returning date provided by a user, such as a costumer, and/or an actual returning date detected by a service provider, such as company). For example, the historical data comprises information associated with previous requests for a time extension. In other words, the historical data comprise, in some examples, the package data of previous shipments of a container. Put differently, the historical data comprise, for example, the time extension parameter (e.g., a time period for returning a container) and the cost parameter (e.g., associated with energy consumption and/or resource utilisation and/or time using a container) associated with the time extension parameter of previous shipments of a container.

The method 100 comprises determining S104, based on the historical data, a container usage pattern associated with the container. For example, the container usage pattern can be determined by using statistical methods taking as input historical data, e.g. to output median and/or average of usage metrics. For example, the container usage pattern can be characterized by container usage parameters, such as return time, mean and/or median per day charges for a time period of extension.

In one or more exemplary methods, determining S104, based on the historical data, a container usage pattern associated with the container comprises determining S104A, based on the historical data, one or more container usage parameters. In one or more exemplary methods, determining S104, based on the historical data, a container usage pattern associated with the container comprises determining S104B, based on the one or more container usage parameters, a container usage pattern associated with the container. In one or more examples, the container usage pattern indicates, based on the historical data (e.g., booking data and/or shipment data and/or equipment data), conditions associated with the booking and/or shipping of a container. For example, a container usage pattern can be seen as a current renting pattern associated with a container. In one or more exemplary methods, the one or more container usage parameters comprise one or more of: a proportion parameter indicative of a proportion of users selecting a respective time extension package, an average delay for returning the container, an average turnaround time for returning the container, one or more rate parameters indicative of a rate for a respective container size and/or a country, one or more extension day for a respective container size and/or a country, a statistical rate parameter indicative of a rate for a respective container size and/or a country, and a statistical extension day for a respective container size and/or a country.

In one or more examples, the average delay for returning the container, and an average turnaround time for returning the container are container usage parameters that are used for determining impact on extension cost data, (e.g., a cannibalisation effect on the Demurrage and Detention (D&D) revenue).

Optionally, the method 100 comprises generating S106, based on the container usage pattern, a time extension package associated with the container shipment characterized by package data. In some example, the package data comprises a time extension parameter indicative of a time period for extending a return time of the container and a cost parameter associated with the time extension parameter. For example the time extension package is characterized by package data including the time extension parameter and its associated cost parameter. For example, the time extension parameter includes the time period for extending a return time of the container. For example the cost parameter can be indicative of energy consumption, resource usage, time usage and/or pricing.

Optionally, the method 100 comprises generating, based on the container usage pattern, the package data.

In one or more examples, a user can require a time extension for returning a container to a container facility. For example, a time extension is an extension in time requested by a user (e.g., a costumer) to return a container to a container facility (e.g., a port and/or a terminal). In one or more examples, a time extension package provides package data that includes time extension parameter, such as a time period, such as a range of days. In other words, the time extension parameter includes a number of days for returning a container. Based on an example container usage pattern, 60% of users (e.g., a proportion parameter) request to return the container on day 5, 20% of users request to return the container on day 9, 10% of costumers request to return the container on day 10, and 20% of users request to return the container on days 1, 2, 3 for returning a container. For example, days 5, 9 and 10 are days with a higher percentage of users requesting to return the container. For example, package data of the time extension package is determined based on the days 5, 9 and 10. In some examples, the time extension package can be recommended by a shipping company to a user.

Optionally, the method 100 comprises generates, based on the container usage pattern, a plurality of time extension packages including a first time extension package (characterized by first package data), a second time extension package (characterized by second package data), and optionally a third time extension package (characterized by third package data) etc. The first package data includes a first time extension parameter and its associated first cost parameter. The second package data includes a second time extension parameter and its associated second cost parameter. The third package data includes a third time extension parameter and its associated third cost parameter.

In one or more exemplary methods, generating S106, based on the container usage pattern, the time extension package comprises generating S106B, based on the container usage pattern, the plurality of time extension packages. In one or more exemplary methods, each time extension package is characterized by corresponding package data.

In one or more exemplary methods, generating S106, based on the container usage pattern, the time extension package comprises generating S106A, based on the container usage pattern, package data indicative of the time extension package.

In one or more exemplary methods, generating S106, based on the container usage pattern, the time extension package comprises generating S106C, for each time extension package, based on the container usage pattern, the respective time extension parameter and the respective cost parameter associated with each time extension package.

In one or more exemplary methods, the time extension parameter comprises the time period.

In one or more exemplary methods, generating S106C for each time extension package, based on the container usage pattern, the respective time extension parameter and the respective cost parameter associated with each time extension package comprises determining S106CA a first cost parameter associated with a first time extension package of the plurality of the time extension packages.

In some examples, the method generates one or more of: first package data of a first time extension package (e.g., 1 to 5 days and cost 1), second package data of a second time extension package (e.g., 6 to 10 days and cost 2), third package data of a third time extension package (e.g., 11 to 14 days and cost 3), fourth package data a fourth time extension package and any other suitable number of time extension packages. In some examples, the time extension package can comprise one or more of: a first time extension parameter (e.g., 1 to 5 days) and associated first cost parameter, a second time extension parameter (e.g., 6 to 10 days) and associated second cost parameter, a third time extension parameter (e.g., 11 to 14 days) and associated third cost parameter, etc.

In one or more exemplary methods, generating S106C for each time extension package, based on the container usage pattern, the respective time extension parameter and the respective cost parameter associated with each time extension package comprises determining S106CB, based on the first cost parameter and a difference parameter, a second cost parameter associated with a second time extension package of the plurality of the time extension packages by maintaining a difference parameter between the first and the second cost parameters. For example, the first and second cost parameter are from subsequent packages in an ordered sequence. The difference parameter can be a percentage, such as 10%. Maintaining the difference parameter can be seen as applying the same percentage. For example, the cost parameter associated with the first time extension parameter is determined based on the difference parameter being a statistical rate parameter (e.g., a median rate per day for a respective container size and/or a country). For example, the cost parameter associated with the second time extension parameter is calculated based on the cost parameter associated with the first time extension parameter (e.g., 10% less than the cost parameter associated with the first time extension parameter). For example, the cost parameter associated with the third time extension parameter is calculated based on the cost parameter associated with the second time extension parameter (e.g., 10% less than the cost parameter associated with the first time extension parameter).

The method 100 comprises predicting S108, for one or more time extension packages of a plurality of time extension packages, a selection parameter by applying a machine-learning model to the historical data and previous package data. The previous package data includes for example historical package data. The selection parameter is indicative of a likelihood of selection of the respective time extension package. For example, the selection parameter is predicted for one or more time extension packages of a plurality of time extension packages, such as for each of the plurality of time extension packages.

For example, the selection parameter can be seen as an acceptance rate and/or adoption rate by a user. In other words, the selection parameter is indicative of a likelihood for user to select a time extension package. For example, a selection parameter comprises an adoption rate for each time extension package of the plurality of time extension packages. For example, applying the machine learning model to the historical data and previous package data provides as output a predicted selection parameter (e.g., an adoption rate) for the one or more time extension packages of the plurality of time extension packages. For example, the selection parameter indicates a likelihood of a user to select the respective time extension package. For example, selecting the respective time extension package comprises selecting the respective time extension package based on the cost parameter associated with the respective time extension parameter.

The method 100 comprises determining S110, based on the selection parameter for one or more time extension packages, extension cost associated with time extension of the container shipment. The extension cost data may be seen as a total cost associated with time extension, such as with the users selecting the time extension packages provided. For example, the extension cost data can include a revenue parameter indicative of a revenue associated with time extension of the container shipment.

The method 100 comprises providing S112, based on the extension cost data, updated package data associated with the time extension package. The extension cost data can be used to update the package data associated with the time extension package, such as to update the time extension parameter and its associated cost parameter. The updated package data can benefit from the extension cost data determined based on the selection parameter, for example based on the likelihood of the user to select the respective time extension package. in other words the updated package data provided for the time extension package is determined such that there is a higher likelihood for the user to select that time extension package. For example the updated package data may be seen as a recommended package data for a recommended time extension package. In some examples, the updated package data may be the same as the package data before update. In some examples, the updated package data may be different than the package data before update. In other words, the package data may or may not be affected by the extension cost data.

In one or more exemplary methods, predicting S108 the selection parameter by applying the machine-learning model to the historical data and the previous package data comprises determining S108A, for the one or more time extension packages, based on the historical data and the previous package data, a first change parameter indicative of change in the cost parameter of the package data and a second change parameter indicative of a corresponding change in the corresponding selection parameter. For example, predicting the selection parameter includes determining, for each time extension package (e.g., a package comprising a number of days for returning a container), based on cost parameters associated with the historical data and the previous package data, a first change parameter and a second change parameter. For example, the first change parameter can be seen as a percentage change in the cost parameter of the package data (e.g., in price of the package data). For example, the second change parameter can be seen as a percentage change in the adoption rate. Put differently, predicting the selection parameter comprises determining, based on cost parameters associated with the historical data and the previous package data, a percentage change in the cost parameter and a corresponding change in the selection parameter, e.g., adoption rate.

In one or more exemplary methods, predicting S108 the selection parameter by applying the machine-learning model to the historical data and the previous package data comprises training S108B the machine learning model based on the first change parameter and the second change parameter. For example, the machine-learning model takes as input the historical data and previous package data. For example, the machine learning outputs the selection parameter. For example, the historical data can include the first change parameter and the second change parameter. In other words, the machine-learning model takes as input the percentage change in the cost parameter and a corresponding change in selection parameter, e.g. adoption rate. The machine learning model can be trained using the historical data.

For example, predicting the selection parameter (e.g., a percentage change in the adoption rate) includes predicting the selection parameter for each time extension packages of the plurality of time extension packages by applying a trained machine-learning model (e.g., a machine-learning model previously trained based on the first change parameter and the second change parameter).

In one or more exemplary methods, the machine learning model includes a linear regression model. In one or more exemplary methods, the machine learning model includes a regularized linear regression model, e.g., which is optimized for higher accuracy. For example, a regularized linear regression model predicts the selection parameter based on the historical data and previous package data. In other words, a regularized linear regression model provides the linear relationship between the selection parameter and the historical data and the previous package data. The selection parameter can be determined by a regularized linear regression based on the historical data and the previous package data.

In one or more exemplary methods, predicting S108 the selection parameter by applying the machine-learning model to the historical data and previous package data comprises determining S108C for the one or more time extension packages, a third change parameter indicative of change in the cost parameter of the package data with respect to a current fixed cost of a time extension package. The third change parameter indicates a change in the cost parameter with respect to a current fixed cost of the corresponding time extension package having the corresponding time extension parameter. For example, the third change parameter is determined for each off the parity of time extension packages. In one or more examples, the third change parameter indicates a percentage change for each cost parameter of a package data of a time extension package with respect to a current fixed cost of the corresponding time extension package. For example, the current fixed cost (e.g., current flat rate) of the time extension package can be seen as a cost (e.g., a price) for acquiring such time extension parameter for extending a time period for returning a container.

In one or more exemplary methods, predicting S108 the selection parameter by applying the machine-learning model to the historical data and previous package data comprises predicting S108D a fourth change parameter indicative of change in the selection parameter for each cost parameter of the package data using the trained machine-learning model. In one or more examples, the fourth change parameter indicates a change percentage in selection parameter (e.g., adoption rate) of a time extension package by a user for each cost parameter of each proposed time extension package using the trained machine-learning model (e.g., for each package data of the time extension package).

In one or more exemplary methods, determining S110, based on the selection parameter for each time extension package, the extension cost data associated with time extension of the container shipment comprises performing S110A a simulation of the extension cost data for the package data of each time extension package based on the selection parameter for each time extension package. In other words, the extension cost data is determined by simulating the cost extension data based on the selection parameter. The extension cost data for each time extension package is obtained by simulating the extension data for each time extension package based on the selection parameter for each time extension package. In one or more exemplary methods, determining S110, based on the selection parameter for each time extension package, the extension cost data associated with time extension of the container shipment comprises generating S110B, based on the simulated extension cost data, the extension cost data.

In one or more exemplary methods, the simulation is a Monte Carlo simulation configured to randomize the selection proportion of each time extension package. In one or more examples, the simulation of the extension cost data for the package data of each time extension package based on the selection parameter (e.g., adoption rate) for each time extension package allows determining a corresponding extension cost data (e.g., including a revenue parameter).

In one or more exemplary methods, performing S110A the simulation comprises generating, for each time extension package, demurrage, and detention cost data indicative of cost of demurrage and detention of the container.

In one or more exemplary methods, the extension cost data comprises the demurrage and detention cost data. In some examples, the extension cost data includes a Demurrage and Detention (D&D) revenue parameter and a time extension revenue parameter.

For example, the Monte Carlo simulation slightly randomizes the consumption proportion of each slab and runs for 1000 iterations. The simulation can calculate the time extension revenue parameter based on the cost parameter for each time extension package. The average of extension cost generated by all iterations is used as input for prediction.

It may be appreciated that the disclosure uses a Machine learning model to predict the selection parameter (e.g. customers adoption) at a particular cost parameter and time extension parameter. The disclosure proposes to use Monte Carlo Simulation technique to predict the approximate extension cost data, e.g. indicative of the time extension revenue.

In one or more exemplary methods, providing S112, based on the extension cost data, updated package data comprises providing S112A, based on a maximum extension cost of the extension cost data, the updated packaged data. In other words the updated package data may maximize the extension cost (represented by the extension cost data, e.g. the total revenue) and can thereby be recommended. After running the simulations for all the candidate price points sequentially, the price point which maximizes the total revenue is considered as optimal and recommended by the tool.

FIG. 2 shows a block diagram of an exemplary electronic device 300 according to the disclosure. The electronic device 300 comprises a memory 301, a processor 302, and an interface 303. The electronic device 300 is configured to perform any of the methods disclosed in FIG. 1. In other words, the electronic device 300 is configured for handling shipment of a container.

The electronic device 300 is configured to obtain (e.g., via the interface 303 and/or using the memory 301) historical data associated with container shipment.

The electronic device 300 is configured to determine (e.g., using the processor 302), based on the historical data, a container usage pattern associated with the container.

The electronic device 300 is configured to generate (e.g., using the processor 302), based on the container usage pattern, a time extension package associated with the container shipment characterized by package data. The package data comprises a time extension parameter indicative of a time period for extending a return time of the container and a cost parameter associated with the time extension parameter.

The electronic device 300 is configured to predict (e.g., using the processor 302), for one or more time extension packages of a plurality of time extension packages, a selection parameter by applying a machine-learning model to the historical data and previous package data. The selection parameter is indicative of a likelihood of selection of the respective time extension package.

The electronic device 300 is configured to determine (e.g., using the processor 302), based on the selection parameter for the one or more time extension packages, extension cost data associated with time extension of the container shipment.

The electronic device 300 is configured to provide (e.g., using the processor 302 and/or the interface 303), based on the extension cost data, updated package data associated with the time extension package.

The electronic device 300 is optionally configured to perform any of the operations disclosed in FIG. 1 (such as any one or more of: S104A, S104B, S106A, S106B, S106C, S106CA, S106CB, S108A, S108B, S108C, S108D, S110A, S110B, S112A). The operations of the electronic device 300 may be embodied in the form of executable logic routines (e.g., lines of code, software programs, etc.) that are stored on a non-transitory computer readable medium (e.g., the memory 301) and are executed by the processor 302.

Furthermore, the operations of the electronic device 300 may be considered a method that the electronic device 300 is configured to carry out. Also, while the described functions and operations may be implemented in software, such functionality may as well be carried out via dedicated hardware or firmware, or some combination of hardware, firmware and/or software.

The memory 301 may be one or more of: a buffer, a flash memory, a hard drive, a removable media, a volatile memory, a non-volatile memory, a random access memory (RAM), and any other suitable device. In a typical arrangement, the memory 301 may include a non-volatile memory for long term data storage and a volatile memory that functions as system memory for the processor 302. The memory 301 may exchange data with the processor 302 over a data bus. Control lines and an address bus between the memory 301 and the processor 302 also may be present (not shown in FIG. 2). The memory 301 is considered a non-transitory computer readable medium.

The memory 301 may be configured to store the historical data, the container usage pattern, the time extension package, the package data, the selection parameter, the extension cost data, the updated package data in a part of the memory.

Embodiments of methods and products (electronic device) according to the disclosure are set out in the following items:
Item 1. A method, performed by an electronic device, for handling shipment of a container, the method comprising:
   obtaining (S102) historical data associated with container shipment;
   determining (S104), based on the historical data, a container usage pattern associated with the container;
   generating (S106), based on the container usage pattern, a time extension package associated with the container shipment characterized by package data, wherein the package data comprises a time extension parameter indicative of a time period for extending a return time of the container and a cost parameter associated with the time extension parameter;
   predicting (S108), for one or more time extension packages of a plurality of time extension packages, a selection parameter indicative of a likelihood of selection of the respective time extension package by applying a machine-learning model to the historical data and previous package data;
   determining (S110), based on the selection parameter for the one or more time extension packages, extension cost data associated with time extension of the container shipment; and
   providing (S112), based on the extension cost data, updated package data associated with the time extension package.
Item 2. The method according to item 1, wherein generating (S106), based on the container usage pattern, the time extension package comprises generating (S106A), based on the container usage pattern, package data indicative of the time extension package.
Item 3. The method according to any of the previous items, wherein generating (S106), based on the container usage pattern, the time extension package comprises:
   generating (S106B), based on the container usage pattern, the plurality of time extension packages, wherein each time extension package is characterized by corresponding package data.
Item 4. The method according to any of the previous items, wherein generating (S106), based on the container usage pattern, the time extension package comprises:
   generating (S106C), for each time extension package, based on the container usage pattern, the respective time extension parameter and the respective cost parameter associated with each time extension package.
Item 5. The method according to any of the previous items, wherein the time extension parameter comprises the time period.
Item 6. The method according to any of items 4-5, wherein generating (S106C) for each time extension package, based on the container usage pattern, the respective time extension parameter and the respective cost parameter associated with each time extension package comprises:
   determining (S106CA) a first cost parameter associated with a first time extension package of the plurality of the time extension packages, and
   determining (S106CB), based on the first cost parameter and a difference parameter, a second cost parameter associated with a second time extension package of the plurality of the time extension packages by maintaining a difference parameter between the first and the second cost parameters.
Item 7. The method according to any of the previous items, wherein predicting (S108) the selection parameter by applying the machine-learning model to the historical data and the previous package data comprises:
   determining (S108A), for the one or more time extension packages, based on the historical data and the previous package data, a first change parameter indicative of change in the cost parameter of the package data and a second change parameter indicative of a corresponding change in the corresponding selection parameter.
Item 8. The method according to item 7, wherein predicting (S108) the selection parameter by applying the machine-learning model to the historical data and the previous package data comprises:
   training (S108B) the machine learning model based on the first change parameter and the second change parameter.
Item 9. The method according to any of the previous items, wherein the machine learning model includes a linear regression model.
Item 10. The method according to any of the previous items, wherein predicting (S108) the selection parameter by applying the machine-learning model to the historical data and previous package data comprises:
   determining (S108C), for the one or more time extension packages, a third change parameter indicative of change in the cost parameter of the package data with respect to a current fixed cost of a time extension package; and
   predicting (S108D) a fourth change parameter indicative of change in the selection parameter for each cost parameter of the package data using the trained machine-learning model.
Item 11. The method according to any of the previous items, wherein determining (S110), based on the selection parameter for each time extension package, the extension cost data associated with time extension of the container shipment comprises:
   performing (S110A) a simulation of the extension cost data for the package data of each time extension package based on the selection parameter for each time extension package; and
   generating (S110B), based on the simulated extension cost data, the extension cost data.
Item 12. The method according to item 11, wherein the simulation is a Monte Carlo simulation configured to randomize the selection proportion of each time extension package.
Item 13. The method according to any of items 11-12, wherein performing (S110A) the simulation comprises generating, for each time extension package, demurrage, and detention cost data indicative of cost of demurrage and detention of the container.
Item 14. The method according to item 13, wherein the extension cost data comprises the demurrage and detention cost data.
Item 15. The method according to any of the previous items, wherein determining (S104), based on the historical data, a container usage pattern associated with the container comprises:
   determining (S104A), based on the historical data, one or more container usage parameters; and
   determining (S104B), based on the one or more container usage parameters, a container usage pattern associated with the container.
Item 16. The method according to any of the previous items, wherein the one or more container usage parameters comprise one or more of:
   a proportion parameter indicative of a proportion of users selecting a respective time extension package,
   an average delay for returning the container, an average turnaround time for returning the container,
   one or more rate parameters indicative of a rate for a respective container size and/or a country,
   one or more extension day for a respective container size and/or a country,
   a statistical rate parameter indicative of a rate for a respective container size and/or a country, and
   a statistical extension day for a respective container size and/or a country.
Item 17. The method according to any of the previous items, wherein providing (S112), based on the extension cost data, updated package data comprises providing (S112A), based on a maximum extension cost of the extension cost data, the updated packaged data.
Item 18. An electronic device comprising a memory, an interface and a processor configured to perform any of the methods according to any of items 1-17.
Item 19. A computer readable storage medium storing one or more programs, the one or more programs comprising instructions, which when executed by an electronic device cause the electronic device to perform any of the methods of items 1-17.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-2 comprise some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by an electronic device, for handling shipment of a container, the method comprising:
obtaining historical data associated with container shipment;
determining, based on the historical data, a container usage pattern associated with the container;
generating, based on the container usage pattern, a time extension package associated with the container shipment characterized by package data, wherein the package data comprises a time extension parameter indicative of a time period for extending a return time of the container and a cost parameter associated with the time extension parameter;
predicting, for one or more time extension packages of a plurality of time extension packages, a selection parameter indicative of a likelihood of selection of the respective time extension package by applying a machine-learning model to the historical data and previous package data;
determining, based on the selection parameter for the one or more time extension packages, extension cost data associated with time extension of the container shipment; and
providing, based on the extension cost data, updated package data associated with the time extension package.

2. The method according to claim 1, wherein generating, based on the container usage pattern, the time extension package comprises generating, based on the container usage pattern, package data indicative of the time extension package.

3. The method according to claim 1, wherein generating (S106), based on the container usage pattern, the time extension package comprises:
generating, based on the container usage pattern, the plurality of time extension packages, wherein each time extension package is characterized by corresponding package data.

4. The method according to claim 1, wherein generating, based on the container usage pattern, the time extension package comprises:
generating, for each time extension package, based on the container usage pattern, the respective time extension parameter and the respective cost parameter associated with each time extension package.

5. The method according to claim 1, wherein the time extension parameter comprises the time period.

6. The method according to claim 4, wherein generating for each time extension package, based on the container usage pattern, the respective time extension parameter and the respective cost parameter associated with each time extension package comprises:
determining a first cost parameter associated with a first time extension package of the plurality of the time extension packages, and
determining, based on the first cost parameter and a difference parameter, a second cost parameter associated with a second time extension package of the plurality of the time extension packages by maintaining a difference parameter between the first and the second cost parameters.

7. The method according to claim 1, wherein predicting the selection parameter by applying the machine-learning model to the historical data and the previous package data comprises:
determining, for the one or more time extension packages, based on the historical data and the previous package data, a first change parameter indicative of change in the cost parameter of the package data and a second change parameter indicative of a corresponding change in the corresponding selection parameter.

8. The method according to claim 7, wherein predicting the selection parameter by applying the machine-learning model to the historical data and the previous package data comprises:
training the machine learning model based on the first change parameter and the second change parameter.

9. The method according to claim 1, wherein the machine learning model includes a linear regression model.

10. The method according to claim 1, wherein predicting the selection parameter by applying the machine-learning model to the historical data and previous package data comprises:
determining, for the one or more time extension packages, a third change parameter indicative of change in the cost parameter of the package data with respect to a current fixed cost of a time extension package; and
predicting a fourth change parameter indicative of change in the selection parameter for each cost parameter of the package data using the trained machine-learning model.

11. The method according to claim 1, wherein determining (S110), based on the selection parameter for each time extension package, the extension cost data associated with time extension of the container shipment comprises:
performing a simulation of the extension cost data for the package data of each time extension package based on the selection parameter for each time extension package; and
generating, based on the simulated extension cost data, the extension cost data.

12. The method according to claim 11, wherein the simulation is a Monte Carlo simulation configured to randomize the selection proportion of each time extension package.

13. The method according to claim 11, wherein performing (S110A) the simulation comprises generating, for each time extension package, demurrage, and detention cost data indicative of cost of demurrage and detention of the container.

14. The method according to claim 13, wherein the extension cost data comprises the demurrage and detention cost data.

15. The method according to claim 1, wherein determining (S104), based on the historical data, a container usage pattern associated with the container comprises:
determining (S104A), based on the historical data, one or more container usage parameters; and
determining (S104B), based on the one or more container usage parameters, a container usage pattern associated with the container.

16. The method according to claim 1, wherein the one or more container usage parameters comprise one or more of: a proportion parameter indicative of a proportion of users selecting a respective time extension package,
an average delay for returning the container, an average turnaround time for returning the container,
one or more rate parameters indicative of a rate for a respective container size and/or a country,
one or more extension day for a respective container size and/or a country,
a statistical rate parameter indicative of a rate for a respective container size and/or a country, and
a statistical extension day for a respective container size and/or a country.

17. The method according to claim 1, wherein providing based on the extension cost data, updated package data comprises providing, based on a maximum extension cost of the extension cost data, the updated packaged data.

18. An electronic device comprising a memory, an interface and a processor configured to perform any the method of claim 1.

19. A computer readable storage medium storing one or more programs, the one or more programs comprising instructions, which when executed by an electronic device cause the electronic device to perform the method of claim 1.
